(19) United States
(12) Patent Application Publication
(10) Pub. No.: US 2023/0086103 A1
(43) Pub. Date: Mar. 23, 2023

(54) EXAM PROCTORING USING CANDIDATE INTERACTION VECTORS

(71) Applicant: International Business Machines Corporation, Armonk, NY (US)

(72) Inventors: Nitin Ramchandani, San Jose, CA (US); Eric Kevin Butler, San Jose, CA (US); ROBERT ENGEL, San Francisco, CA (US); ALY MEGAHED, San Jose, CA (US); YUYA JEREMY ONG, San Jose, CA (US)

(21) Appl. No.: 17/477,733

(22) Filed: Sep. 17, 2021

(51) Int. Cl. G09B 7/06; G06N 20/00

(52) U.S. Cl. CPC G09B 7/06; G06N 20/00

(57) ABSTRACT

In a method for determining anomalous behavior of a candidate taking an exam, a processor receives first exam interface input values captured during an exam session on a candidate testing device. A processor generates a first interaction vector from the first exam interface input values. A processor generates a first interaction timeline from the first interaction vector. A processor determines an anomalous behavior based on a relationship between the first interaction timeline and a selected classification cluster.

### BACKGROUND OF THE INVENTION

The present invention relates generally to the field of automated exam proctoring, and more particularly to determining exam candidate behavior based on interactions with the exam interface. Proctoring of exams has traditionally been done in-person by a proctor who manually checks the identity of each student, and ensures all academic guidelines are followed during an exam session.

Distance learning and remote e-learning has become more popular these days because of its flexibility and availability. The remote learning community is being forced to determine how to efficiently proctor the exams remotely and ensure no academic dishonesty occurs during an exam session. Many of the schools and institutes also have adapted to remote exam during this pandemic, the ease and flexibility remote exam provides suggest this will continue post pandemic too. Online proctored exams are online tests (timed or untimed) that you take while a remote proctor and/or proctoring software observes you and your computer using your desktop, webcam video, and audio. Like traditional proctoring, online proctoring involves a proctor who observes the test-taker in order to confirm their identity, answer any questions they may have, and to prevent, identify, and/or report cheating and malpractice.

### SUMMARY

Aspects of an embodiment of the present invention disclose a method, computer program product, and computing system for determining anomalous behavior of a candidate taking an exam. A processor receives first exam interface input values captured during an exam session on a candidate testing device. A processor generates a first interaction vector from the first exam interface input values. A processor generates a first interaction timeline from the first interaction vector. A processor determines an anomalous behavior based on a relationship between the first interaction timeline and a selected classification cluster.

### BRIEF DESCRIPTION OF THE DRAWINGS

FIG. 1 depicts a diagram of a system in accordance with one embodiment of the present invention.

FIG. 2 depicts a flowchart of the steps of a proctoring program executing within the system of FIG. 1, for proctoring candidates taking an exam, in accordance with one embodiment of the present invention.

FIGS. 3A, 3B, and 3C depict tables showing interaction vectors organized into a problem-level interaction timeline, a partial-exam interaction timeline, and an exam-level interaction timeline, in accordance with one embodiment of the present invention.

FIG. 4 depicts graphical representations of exam interface input values 404 that may be received by the proctoring program 120, in accordance with one embodiment of the present invention.

FIG. 5 depicts a block diagram of components of a computing device representing a server, a proctoring device, and a candidate testing device, in accordance with one embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions

Jul. 28, 2015 by utilizing state information of the computer readable program instructions to personalize the electronic circuitry, in order to perform aspects of the present invention. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

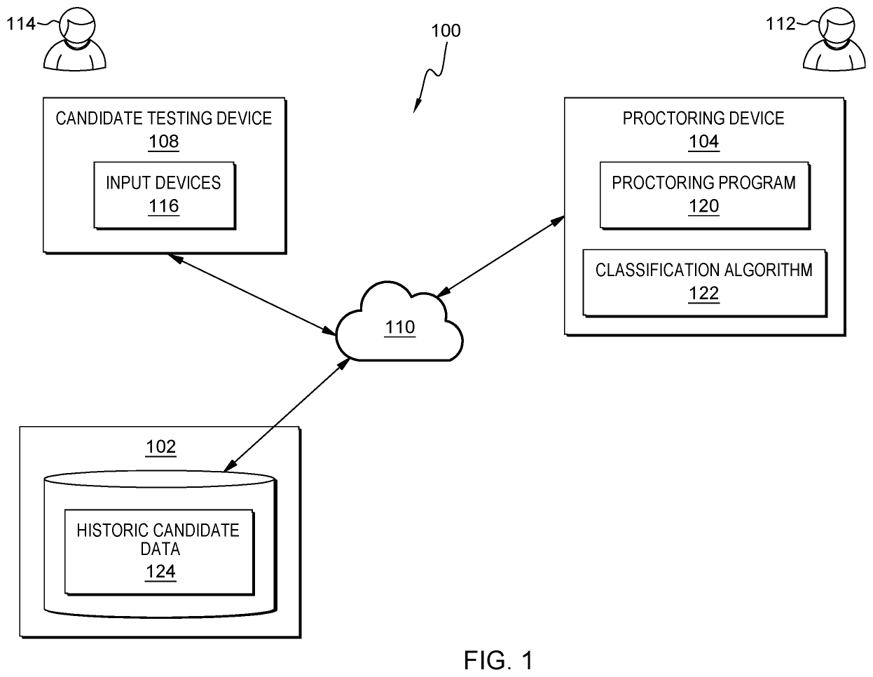

Turning now to the drawings, FIG. 1 depicts a diagram of a remote proctoring system 100 in accordance with one embodiment of the present invention. FIG. 1 provides only an illustration of one embodiment and does not imply any limitations with regard to the environments in which different embodiments may be implemented.

The remote proctoring system 100 includes a server 102 (e.g., database, filesystem), a proctoring device 104, and a candidate testing device 108. In certain embodiments, as illustrated, the server 102, the proctoring device 104, and the candidate testing device 108 are communicatively coupled via a communication network 110. The communication network 110 may be a single machine, a local area network (LAN), a wide area network (WAN) such as the Internet, any combination thereof, or any combination of connections and protocols that will support communications between the server 102, the proctoring device 104, and the candidate testing device 108 in accordance with embodiments of the invention. The communication network 110 may include wired, wireless, or fiber optic connections. In certain embodiments, the server 102, the proctoring device 104, and the candidate testing device 108 may communicate without requiring the communication network 110, instead communicating via one or more dedicated wire connections or other forms of wired and wireless electronic communication.

The remote proctoring system 100 operates to enable an exam authority 112 to monitor a candidate 114 taking an exam from any location with a connection to the communication network 110. While a single candidate 114 is illustrated, the remote proctoring system 100 may be used to proctor many (e.g., dozens, hundreds) candidates 114 simultaneously through the communication network 110. The candidate 114 interacts with the candidate testing device 108, which has input devices 116 such as a mouse, keyboard, microphone, camera, stylus, or others. The input devices 116 record exam interface input values during the exam. The exam authority 112 (i.e., a person or persons monitoring the candidate 114 or many candidates 114) is tasked with monitoring the exam interface input values, and uses the proctoring device 104 to conduct a number of machine-only techniques to ensure all the candidates follow the established rules for the exam. For example, the proctoring device 104 may use the camera of the candidate testing device 108 to authenticate the candidate 114 (i.e., face recognition), or to detect use of a non-approved device, or detect whether candidate (or unapproved person) is in camera view. The proctoring device 104 may also use the microphone detect suspicious audio, or may lock down the web browser or other computer functions (e.g., copy/paste) to ensure rule compliance.

Many of these machine-only techniques, however, can be circumvented by candidates 114 looking to break exam rules. Therefore, the embodiments disclosed herein may further include feature representation that encodes temporal behavior, interaction patterns, and audio and visual patterns of the candidate 114 to create a more robust artificial intelligence (AI) proctoring system. Specifically, the proctoring device 104 employs a proctoring program 120, that determines anomalous behavior based on classifications of the detected exam interface input values.

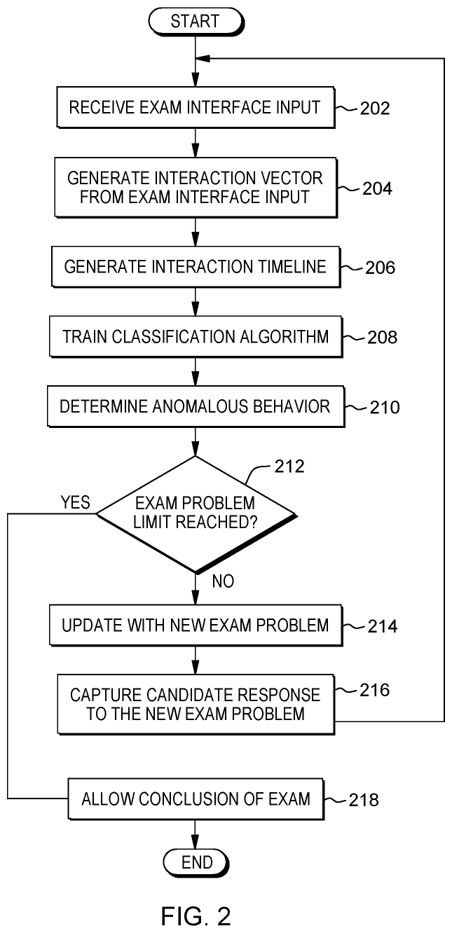

FIG. 2 depicts a flowchart of the steps of a proctoring program 120 executing within the system of FIG. 1, for proctoring candidates 114 taking an exam, in accordance with one embodiment of the present invention. The proctoring program 120 receives the exam interface input values from the candidate testing device 108 (block 202). The exam interface input values may include actions detected and collected by the input devices 116 (as mentioned above), and may also include exam-specific metrics detected within the exam software on the candidate testing device 108.

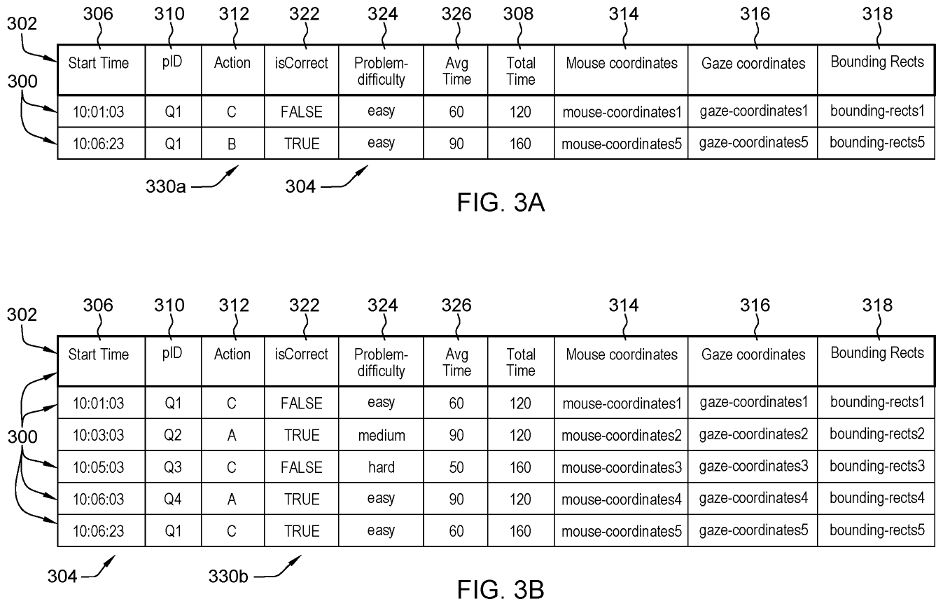

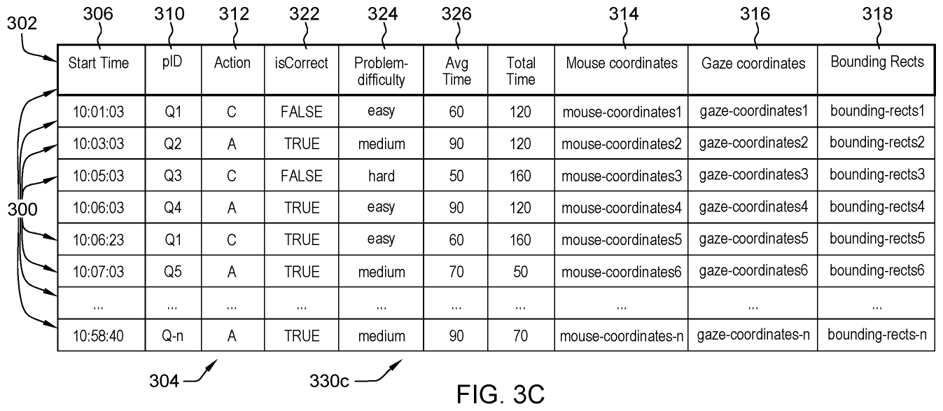

The proctoring program 120 may also determine interaction vectors from the exam interface input values (block 204). FIGS. 3A, 3B, and 3C depict interaction vectors 300 determined from exam interface inputs 302 in accordance with one embodiment of the present invention. The proctoring program 120 receives exam interface input values 304 for each of the exam interface inputs 302. The exam interface input values 304 may include numeric values, words, coordinates, or shapes representing interactive areas of the exam interface.

In particular, the exam interface inputs may include values for the exam interface inputs 302 shown in FIGS. 3A, 3B, and 3C. A start time 306 and a total time 308 may be received by the proctoring program 120 for the exam as a whole, or for more specific time points/periods. The interaction vectors 300 show the start and total time for each interaction with an exam problem. The exam interface inputs 302 may also include a problem ID 310 and an answer selection 312. Certain types of exams may include further choices for selection options such as a review-later flag selection. The interaction vectors 300 may also include exam interface inputs 302 such as mouse coordinates 314, gaze coordinates 316, and bounding rectangles 318. and exam problem navigation selection. The gaze coordinates and body gestures may be captured using known artificial intelligence (AI) techniques, such as eye/body tracking through the use of the camera.

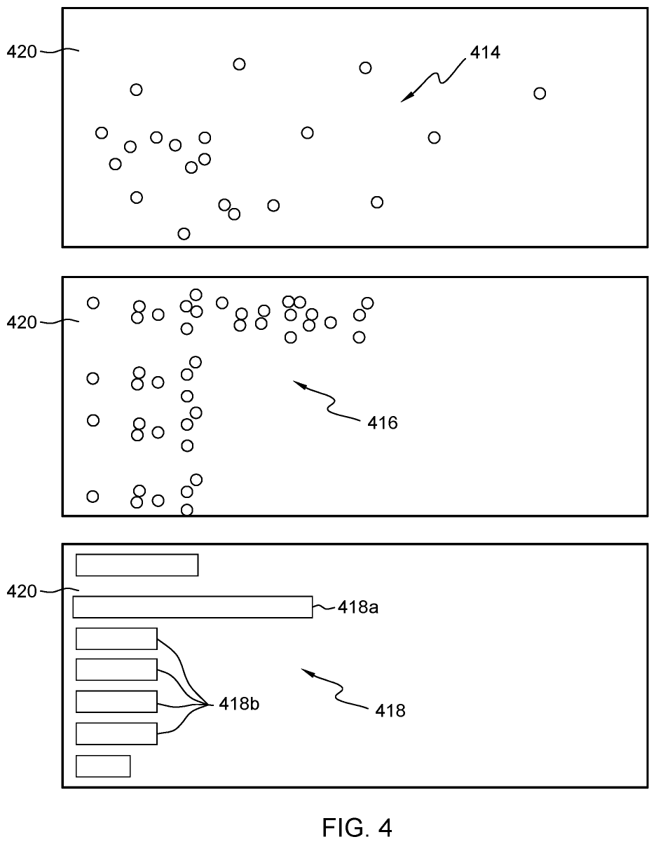

FIG. 4 depicts graphical representations of exam interface input values 404 that may be received by the proctoring program 120, in accordance with one embodiment of the present invention. The exam interface input values 404 show the graphical representation of mouse coordinates 414, gaze coordinates 416, and bounding rectangles 418 within an interface area 420. The interface area 420 is determined by the area of the exam interface on the candidate testing device 108. For example, the interface area 420 depicted in FIG. 4 is shown in a landscape orientation, but the interface area 420 may include a portrait orientation or multiple-screen orientation. The mouse coordinates 414 may be points within the interface area 420 that are captured using a variety of capture methods. For example, the mouse coordinates 414 may be captured at regular time intervals, or based on movement/non-movement of the mouse. Similarly, the gaze coordinates 416 may be captured using a variety of timing and eye tracking techniques. The bounding rectangles 418 may be captured for each exam problem, and indicate separate areas of interaction such as question prompt bounding rectangle 418a and answer choices 418b.

The interaction vector 300 may also include exam interface inputs 302 that are determined from information outside of the direct input of the candidate 114. For example, the interaction vector 300 may include a correctness indication 322 indicating whether the answer selection 312 is correct. The exam interface input value 304 for the correctness indication 322 does not come from the candidate 114, but rather is a comparison between the answer selection 312 and a stored correct value associated with the problem ID 310. A problem difficulty 324 also a stored value that is associated with the problem ID 310. An average time 326 exam interface input 302 is a stored value of the mathematical average of all examples of total time 308 for any number (e.g., all-time total, total for last month) of candidates 114 that have taken the exam problem associated with the problem ID 310.

The exam interface inputs 302 may further include examples not shown in the interaction vector 300 of FIGS. 3A, 3B, and 3C. For example, the exam interface inputs 302 may include interface states. The interface states may include screenshots of the exam interface of the candidate testing device 108, and may also pair the screenshots with additional information: (timestamp, screenshot); or (timestamp, bounding rectangle) where the bounding rectangle is defined for each exam problem (e.g., bounding rectangle for the prompt, another bounding rectangle for each answer choice).

Returning to FIG. 2, the proctoring program 120 may then also generate an interaction timeline 330 from the interaction vector (block 206). Examples of interaction timelines include a problem-level interaction timeline 330a, a partial-exam interaction timeline 330b, and an exam-level interaction timeline 330c. The problem-level interaction timeline 330a may include multiple instances of time when the candidate 114 is viewing the exam problem. In the illustrated problem-level interaction timeline 330a, the candidate 114 has spent two separate instances of time viewing the exam problem. In certain problem-level interaction timelines 330a, the candidate 114 may spend only one instance viewing the exam problem, in which case the problem-level interaction timeline 330a will only include one interaction vector 300 rather than two.

The partial-exam interaction timeline 330b may include interaction vectors 300 from selected exam problems. The exam problems may be selected for a particular difficulty, a particular amount of total time 308, a particular subject matter covered by the exam problem, or other criteria selected by the proctoring program 120 or by the exam authority 112. The exam-level interaction timeline 330c includes the interaction vectors 300 from all the exam problems.

The proctoring program 120 may also train a classification algorithm 122 to determine a plurality of classification clusters based on historic candidate data 124 (block 208). The historic candidate data 124 may be stored on the server 102 and may include interaction vectors 300. The classification clusters may be trained as part of the proctoring program 120, or may be trained separately such that the classification algorithm 130 may be uploaded to the proctoring device 104 from a separate training device that is in connection with the communication network 110. The classification algorithm 122 may be trained using known classification and/or clustering techniques.

For example, training the classification algorithm 122 may include splitting the historic candidate data. The split may be based on a criteria, or may be split randomly. The initial splitting of the historic candidate data can influence the total classification time, but in certain instances a random splitting improves the time and resource usage of the training process. Training the classification algorithm 122 may also include creating subsamples of partial timelines for training, transforming the partial timelines to transformed interaction timelines, initializing model parameters for a clustering algorithm, and feeding the transformed interaction timelines to a clustering model to compute cluster-centroids. From the computed cluster-centroids, the classification algorithm 122 may be trained using conventional clustering algorithms such as library installation, clustering dataset, affinity propagation, agglomerative clustering, birch, dbscan, k-means, mini-batch k-means, mean shift, optics, spectral clustering, or gaussian mixture model. After the clustering step is completed, the exam authority 112 may review samples from clusters identified and tag those cluster for various behaviors like normal behavior, cheating behavior, behavior which shows student struggling with a domain. Based on the exam authority 112 review of the identified clusters, the classification algorithm 122 can re-run model training with the updated model parameters.

The proctoring program 120 may also determine anomalous behavior based on a relationship between the interaction timelines 330 and a selected classification cluster (block 210). The selected classification cluster is selected from the classification clusters determined during training. The proctoring program 120 determines anomalous behavior with the understanding that most candidates 114 follow a specified interaction pattern with an exam interface. For instance, the candidate 114 typically will solve the exam problems in a sequence, and might flag certain questions to revisit. Or, in other scenarios he will solve the problems in a sequence but can switch between domains (i.e., types of exam problems covering a certain topic or knowledge base). These examples attribute to ideal interaction pattern from candidates and the proctoring program 120 captures this in a classification cluster representing an interaction timeline across whole exam (e.g., interaction timeline 330c).

If the candidate 114 is moving back and forth across the exam interface and is switching option choices from incorrect (or none) to correct in a short time interval, this will be considered anomalous/outlier pattern as this interaction pattern will deviate from the normal interaction pattern discussed above. The proctoring program 120 may also identify anomalous behavior for multiple candidates 114 if actions taken by these candidates 114 match to a certain threshold (i.e., if the interaction timelines 330 from the candidates lie very close to each other in embedding space). If time taken by candidate to solve the problem is much lower than historical average, the proctoring program 120 should be able to identify this behavior by using historical data.

The proctoring program 120 may also determine anomalous behavior if the candidate 114 is attempting to use any other material or tool during the exam. For example, proctoring systems can lock down browsing during the exam such that the candidate 114 cannot move away from a specific page or browser, but one loophole candidates 114 use to circumvent this exam lockdown is to attempt conduct the exam in a Virtual Machine and use a Host machine to do any exam related searches over the internet. To detect this behavior, the proctoring program 120 correlates the mouse coordinates 314, gaze coordinates 316, and bounding rectangles 318 with data from different devices to identify inconsistencies and determine anomalous behavior.

For example, the interaction timeline that indicates the anomalous behavior may be a problem-level interaction timeline. Or, the interaction timeline that indicates the anomalous behavior may be an exam-level interaction timeline, such that the proctoring program 120 may further determine which part of the exam-level interaction timeline is anomalous by dividing the whole timeline to chunks of problem-level interaction timelines and classifying the problem-level interaction timelines as normal or anomalous timeline. This step enables the proctoring program 120 to pinpoint the exact problem ID where cheating/anomalous behavior is suspected for the candidate 114.

The proctoring program 120 may also compute an anomaly score as part of the determination of the anomalous behavior. The anomaly score may represent a degree of differentiation from the normal behavior for that interaction timeline, and may further include identification of the anomalous behavior being either cheating, distraction, difficulty with a domain or question type, or other reason for behavior. The proctoring program 120 may also include a functionality for reporting the anomaly score and the associated problem ID to the exam authority 112.

During live exam sessions, the proctoring program 120 may confirm whether the anomalous behavior is cheating, distraction, difficulty with a domain or question type, or another reason for behavior. The proctoring program 120 may confirm the anomalous behavior by initially determining whether an exam problem limit has been reached (block 212). That is, when the proctoring program 120 initially sets of the exam, the given problems may include a set that is less than the maximum allowed for the exam. This reduced problem set enables the proctoring program 120 to dynamically respond to any anomalous behavior determined during the live exam session. For example, if the exam problem limit has not been reached (block 212, “No”) the proctoring program 120 may update the exam with a new exam problem (block 214). The new exam problem may include a similar problem type to a problem type of the interaction timeline that indicated the anomalous behavior. Additionally or alternatively, the new exam problem may include a similar problem domain to a problem domain of the interaction timeline that indicated the anomalous behavior. When the exam has been updated, the proctoring program 120 captures further response by the candidate 114 in response to the new exam problem (block 216). This response is captured in the form of new exam interface input values such that the process is repeated from block 202.

If the exam problem limit has been reached (block 212, “Yes”), this means that the proctoring program 120 does not have an opportunity to update any further exam problems, and the candidate 114 is allowed to continue the exam to conclusion (e.g., finishes all questions or finishes the time allotted) (block 218).

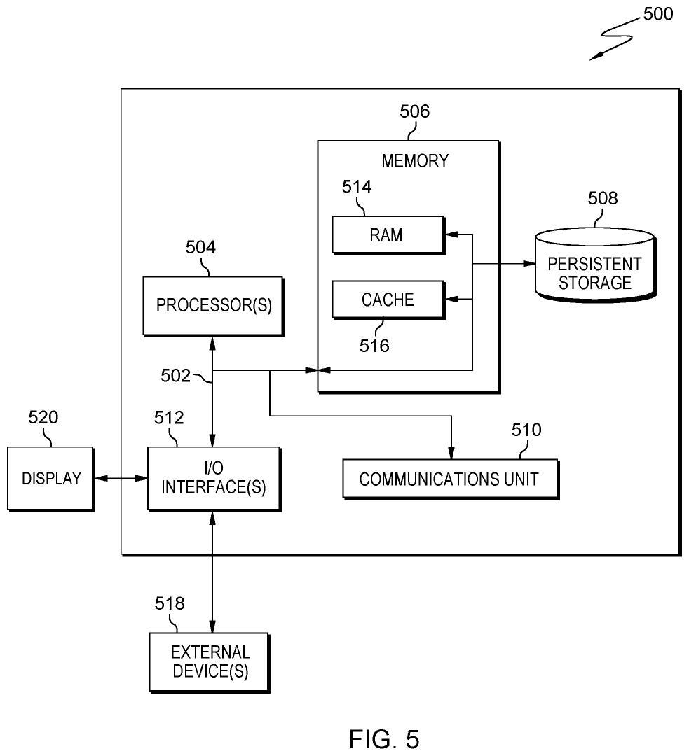

FIG. 5 depicts a block diagram of components of a computing device 500 that represents any of the devices (e.g., the server 102, the proctoring device 104, and the candidate testing device 108) in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

The proctoring program 120 and the classification algorithm 122 are stored in persistent storage 508 of computing device 500 for execution by one or more of the respective computer processors 504 of computing device 500 via one or more memories of memory 506 of computing device 500. The proctoring program 120 and the classification algorithm 122 are stored for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. The proctoring program 120 and the classification algorithm 122 may be downloaded to persistent storage 508 of computing device 50 through communications unit 510 of the computing device 500. The proctoring program 120 and the classification algorithm 122 may be downloaded to persistent storage 508 of the computing device 500 through communications unit 510.

I/O interface(s) 512 allows for input and output of data with other devices that may be connected to the computing device 500. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., haptic program 120, can be stored on such portable computer-readable storage media and can be loaded onto persistent storage 508 of the computing device 500 via I/O interface(s) 512 of the computing device 500. Software and data used to practice embodiments of the present invention, e.g., the proctoring program 120 and the classification algorithm 122, can be stored on such portable computer-readable storage media and can be loaded onto persistent storage via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for determining anomalous behavior of a candidate taking an exam, the method comprising:
receiving, by one or more processors, first exam interface input values captured during an exam session on a candidate testing device;
generating a first interaction vector from the first exam interface input values;
generating a first interaction timeline from the first interaction vector; and
determining, by one or more processors, an anomalous behavior based on a relationship between the first interaction timeline and a selected classification cluster.

2. The method of claim 1, further comprising training a classification algorithm to determine a plurality of classification clusters based on historic candidate data comprising interaction vectors, wherein the classification clusters comprise the selected classification cluster.

3. The method of claim 2, wherein training the classification algorithm comprises:
splitting the historic candidate data;
creating subsamples of partial timelines for training;
transforming the partial timelines to transformed interaction timelines;
initializing model parameters for a clustering algorithm; and
feeding the transformed interaction timelines to a clustering model to compute cluster-centroids.

4. The method of claim 1, further comprising:
determining that an exam problem limit has not been reached;
updating the exam session with a new exam problem comprising a similar problem type to a problem type of the first interaction timeline, and a similar problem domain to a problem domain of the first interaction timeline;
capturing a candidate response to the new exam problem as a second exam interface input.

5. The method of claim 1, further comprising:
computing an anomaly score for the anomalous behavior;
reporting the anomaly score and a problem ID to an exam authority.

6. The method of claim 1, further comprising:
receiving a second exam interface input, wherein the first exam interface input comprises detection of a candidate during a first exam problem, and the second exam interface input comprises detection of a candidate during a second exam problem.

7. The method of claim 1, further comprising:
receiving a second exam interface input, wherein the first exam interface input comprises detection of a candidate during between a first action and a second action, and the second exam interface input comprises detection of a candidate between the second action and a third action.

8. The method of claim 1, wherein the first interaction timeline comprises a selection from the group consisting of: (i) a problem-level interaction timeline, (ii) a partial exam-level interaction timeline, (iii) and an exam-level timeline.

9. The method of claim 1, wherein the exam interface input comprises a selection from the group consisting of: a start-time, a total time, a problem ID, an answer choice selection, a review-later flag selection, an exam problem navigation selection, a sequence of test interface states over all timestamps, mouse coordinates, gaze coordinates, and body gestures.

10. A computer program product for determining anomalous behavior of a candidate taking an exam, the computer program product comprising:
one or more computer-readable storage media and program instructions stored on the one or more computer-readable storage media, the program instructions comprising:
program instructions to receive first exam interface input values captured during an exam session on a candidate testing device;
program instructions to generate a first interaction vector from the first exam interface input values;
program instructions to generate a first interaction timeline from the first interaction vector; and
program instructions to determine an anomalous behavior based on a relationship between the first interaction timeline and a selected classification cluster.

11. The computer program product of claim 10, further comprising program instructions to train a classification algorithm to determine a plurality of classification clusters based on historic candidate data comprising interaction vectors, wherein the classification clusters comprise the selected classification cluster.

12. The computer program product of claim 11, wherein training the classification algorithm comprises:
splitting the historic candidate data;
creating subsamples of partial timelines for training;
transforming the partial timelines to transformed interaction timelines;
initializing model parameters for a clustering algorithm; and
feeding the transformed interaction timelines to a clustering model to compute cluster-centroids.

13. The computer program product of claim 10, further comprising:
program instructions to determine that an exam problem limit has not been reached;
program instructions to update the exam session with a new exam problem comprising a similar problem type to a problem type of the first interaction timeline, and a similar problem domain to a problem domain of the first interaction timeline;
program instructions to capture a candidate response to the new exam problem as a second exam interface input.

14. The computer program product of claim 10, wherein the first interaction timeline comprises a selection from the group consisting of: (i) a problem-level interaction timeline, (ii) a partial exam-level interaction timeline, (iii) and an exam-level timeline.

15. A computer system for determining anomalous behavior of a candidate taking an exam, the computer system comprising:
One or more computer processors, one or more computer-readable storage media, and program instructions stored on the computer-readable storage media for execution by at least one of the one or more processors, the program instructions comprising:
program instructions to receive first exam interface input values captured during an exam session on a candidate testing device;
program instructions to generate a first interaction vector from the first exam interface input values;
program instructions to generate a first interaction timeline from the first interaction vector; and
program instructions to determine an anomalous behavior based on a relationship between the first interaction timeline and a selected classification cluster.

16. The computer system of claim 15, wherein the exam interface input comprises a selection from the group consisting of: a start-time, a total time, a problem ID, an answer choice selection, a review-later flag selection, an exam problem navigation selection, a sequence of test interface states over all timestamps, mouse coordinates, gaze coordinates, and body gestures.

17. The computer system of claim 15, wherein the program instructions comprise program instructions to receive a second exam interface input, wherein the first exam interface input comprises detection of a candidate during between a first action and a second action, and the second exam interface input comprises detection of a candidate between the second action and a third action.

18. The computer system of claim 15, wherein the program instructions comprise:
program instructions to compute an anomaly score for the anomalous behavior; and
program instructions to report the anomaly score and a problem ID to an exam authority.

19. The computer system of claim 15, wherein the program instructions comprise program instructions to train a classification algorithm to determine a plurality of classification clusters based on historic candidate data comprising interaction vectors, wherein the classification clusters comprise the selected classification cluster.

20. The computer system of claim 19, wherein training the classification algorithm comprises:
splitting the historic candidate data;
creating subsamples of partial timelines for training;
transforming the partial timelines to transformed interaction timelines;
initializing model parameters for a clustering algorithm; and
feeding the transformed interaction timelines to a clustering model to compute cluster-centroids.
